(19) United States
(12) Patent Application Publication
(10) Pub. No.: US 2026/0170672 A1
(43) Pub. Date: Jun. 18, 2026

(54) IMAGE SEGMENTATION-BASED DEPTH ESTIMATION SYSTEM AND METHOD THEREOF

(71) Applicant: LITE-ON TECHNOLOGY CORPORATION, TAIPEI CITY (TW)

(72) Inventors: Tzu Chia LIU, Taipei City (TW); Chih-Yuan CHUANG, Taipei City (TW); Chuen Ning HSU, Taipei City (TW); Jiun-Shiung CHEN, Taipei City (TW)

(21) Appl. No.: 19/393,951

(22) Filed: Nov. 19, 2025

Related U.S. Application Data
(60) Provisional application No. 63/735,451, filed on Dec. 18, 2024.
(60) Provisional application No. 63/788,182, filed on Apr. 14, 2025.

(51) Int. Cl. G06T 7/536; G06T 7/00; G06V 10/77

(52) U.S. Cl. CPC G06T 7/536; G06T 7/97; G06V 10/7715

(57) ABSTRACT

A depth estimation system based on image segmentation is provided. The system includes a first camera device for capturing an observed image, a second camera device for capturing a target image, and a processing unit executing instructions stored in a storage unit. The processing unit generates feature maps through feature extraction, identifies multiple segments in the images through an image segmentation process, computes an epipolar constraint for each observed point, performs segment-level and pixel-level matching based on the epipolar constraint to obtain a target point corresponding to the observed point, and estimates a depth value based on the disparity between the observed point and the corresponding target point.

### CROSS REFERENCE TO RELATED APPLICATIONS

This application claims the benefit of U.S. provisional application No. 63/735,451, filed Dec. 18, 2024, and U.S. provisional application No. 63/788,182, filed Apr. 14, 2025, the entirety of which are incorporated by reference herein.

### TECHNICAL FIELD

The present disclosure relates to image analysis and depth estimation techniques, and, in particular, to an image segmentation-based depth estimation system.

### BACKGROUND

Depth estimation is a fundamental task in computer vision and is widely applied in autonomous driving, robotics, and environmental perception. When estimating depth using multiple sensors or cameras, the system generally identifies the same object captured from different viewpoints, and computes the relative distance between the sensors and the object based on the disparity of the captured images. Accordingly, the accuracy of feature matching between corresponding regions or objects in different images plays a crucial role in the overall reliability of depth estimation.

However, feature matching between images obtained from different viewpoints is a challenging task. In practice, even the same physical object may appear significantly different due to variations in illumination, viewing angle, image scale, or lens distortion, causing conventional algorithms to misidentify corresponding points or objects.

To mitigate such issues, conventional stereo vision systems often adopt cameras with identical specifications and restrict their installation to parallel orientations and small baseline shifts, so as to maintain image similarity and facilitate feature matching. This configuration limits the design flexibility and deployment adaptability of the sensing system.

Therefore, there is a need for a depth estimation system and method capable of addressing the above limitations and providing accurate and reliable depth estimation.

### BRIEF SUMMARY

An embodiment of the present disclosure provides a depth estimation system based on image segmentation. The system includes a first camera device configured to capture an observed image, and a second camera device configured to capture a target image. The system further includes a processing unit and a storage unit coupled to the processing unit. The storage unit stores instructions that, when executed by the processing unit, cause the processing unit to generate a first feature map and a second feature map through feature extraction based on the observed image and the target image, respectively. The instructions further cause the processing unit to identify multiple segments in each of the observed image and the target image through an image segmentation process. For each observed point in the observed image, the instructions further cause the processing unit to: compute an epipolar constraint corresponding to the observed point based on extrinsic parameters of the first camera device and the second camera device; identify, among the multiple segments in the observed image, an observed segment in which the observed point is located; determine, among the multiple segments in the target image, a target segment matching the observed segment based on the epipolar constraint; search within the target segment for a target point matching the observed point based on the first feature map, the second feature map, and the epipolar constraint; and estimate a depth value based on the disparity between the observed point and the target point.

In an embodiment, the processing unit determines the target segment by executing steps including: determining, among the multiple segments in the target image, one or more candidate segments based on the epipolar constraint; and filtering the candidate segments by selecting only those having a semantic category identical to that of the observed segment.

In an embodiment, the processing unit determines the target segment by executing steps including: determining, among the multiple segments in the target image, one or more candidate segments based on the epipolar constraint; and filtering the candidate segments by selecting only those having an appearance similarity to the observed segment greater than a similarity threshold.

In an embodiment, the processing unit calculates the appearance similarity between the observed segment and each of the candidate segments based on the first feature map and the second feature map.

In an embodiment, the processing unit determines the target segment by executing steps including: determining, among the multiple segments in the target image, one or more candidate segments based on the epipolar constraint; calculating an observed distance between the first camera device and a ground point of the observed segment in a bird's-eye view coordinate system; calculating, for each candidate segment, a candidate distance between the first camera device and the ground point of the candidate segment in the bird's-eye view coordinate system; and selecting, as the target segment, the candidate segment whose candidate distance has a minimum difference from the observed distance.

In an embodiment, the instructions further cause the processing unit to evaluate a distinctiveness score of each of the multiple segments in the observed image and the target image, and assigns a texture-less tag to those segments whose distinctiveness score is lower than a distinctiveness threshold; generate reliable depth information from the depth values estimated for the segments without the texture-less tag, and refine the depth values of the segments having the texture-less tag to obtain refined depth information; and integrate the reliable depth information and the refined depth information to generate a depth map.

In an embodiment, the processing unit calculates the distinctiveness score of each of the multiple segments based on the variance of feature values within the segment. The variance of the feature values is calculated based on at least one of the first feature map and the second feature map.

In an embodiment, the instructions further cause the processing unit to determine, for each of the segments having the texture-less tag, whether the segment has a sufficient number of matching points. The instructions further cause the processing unit to mark the depth values of those segments having an insufficient number of matching points as invalid in the refined depth information.

In an embodiment, the instructions further cause the processing unit to determine, for each of the segments having the texture-less tag with the sufficient number of matching points, whether the depth values of matching points within the segment are continuous. The instructions further cause the processing unit to mark the depth values of those segments in which the depth values are non-continuous as invalid in the refined depth information.

In an embodiment, the instructions further cause the processing unit to assign interpolated depth values to the segments having the texture-less tag with the sufficient number of matching points and continuous depth values of the matching points, and include the interpolated depth values in the refined depth information.

In an embodiment, the first camera device is a pinhole camera, and the second camera device is a fisheye camera.

In an embodiment, the instructions further cause the processing unit to apply the depth values estimated from the observed points and the target points to perform obstacle detection in at least one of an autonomous navigation system or an advanced driver assistance system.

In an embodiment, the instructions further cause the processing unit to apply the depth values estimated from the observed points and the target points to perform scene reconstruction in an augmented reality or virtual reality system.

An embodiment of the present disclosure provides a depth estimation method based on image segmentation. The method is executed by a processing unit, and includes: generating a first feature map and a second feature map through feature extraction based on an observed image and a target image, respectively; and identifying multiple segments in each of the observed image and the target image through an image segmentation process. The observed image is captured by a first camera device, and the target image is captured by a second camera device. For each observed point in the observed image, the method further includes: computing an epipolar constraint corresponding to the observed point based on extrinsic parameters of the first camera device and the second camera device; identifying, among the multiple segments in the observed image, an observed segment in which the observed point is located; determining, among the multiple segments in the target image, a target segment matching the observed segment based on the epipolar constraint; searching within the target segment for a target point matching the observed point based on the first feature map, the second feature map, and the epipolar constraint; and estimating a depth value based on the disparity between the observed point and the target point.

In an embodiment, the determination of the target segment includes: determining, among the multiple segments in the target image, one or more candidate segments based on the epipolar constraint; and filtering the candidate segments by selecting only those having a semantic category identical to that of the observed segment.

In an embodiment, the determination of the target segment includes: determining, among the multiple segments in the target image, one or more candidate segments based on the epipolar constraint; and filtering the candidate segments by selecting only those having an appearance similarity to the observed segment greater than a similarity threshold.

In an embodiment, the appearance similarity between the observed segment and each of the candidate segments is calculated based on the first feature map and the second feature map.

In an embodiment, the determination of the target segment includes: determining, among the multiple segments in the target image, one or more candidate segments based on the epipolar constraint; calculating an observed distance between the first camera device and a ground point of the observed segment in a bird's-eye view coordinate system; calculating, for each candidate segment, a candidate distance between the first camera device and the ground point of the candidate segment in the bird's-eye view coordinate system; and selecting, as the target segment, the candidate segment whose candidate distance has a minimum difference from the observed distance.

In an embodiment, the method further includes: evaluating a distinctiveness score of each of the multiple segments in the observed image and the target image, and assigns a texture-less tag to those segments whose distinctiveness score is lower than a distinctiveness threshold; generating reliable depth information from the depth values estimated for the segments without the texture-less tag, and refine the depth values of the segments having the texture-less tag to obtain refined depth information; and integrating the reliable depth information and the refined depth information to generate a depth map.

In an embodiment, the distinctiveness score of each of the multiple segments is calculated based on the variance of feature values within the segment. The variance of the feature values is calculated based on at least one of the first feature map and the second feature map.

In an embodiment, the method further includes: determining, for each of the segments having the texture-less tag, whether the segment has a sufficient number of matching points; and marking the depth values of those segments having an insufficient number of matching points as invalid in the refined depth information.

In an embodiment, the method further includes: determining, for each of the segments having the texture-less tag with the sufficient number of matching points, whether the depth values of matching points within the segment are continuous; and marking the depth values of those segments in which the depth values are non-continuous as invalid in the refined depth information.

In an embodiment, the method further includes: determining, for each of the segments having the texture-less tag with the sufficient number of matching points, whether the depth values of matching points within the segment are continuous; and marking the depth values of those segments in which the depth values are non-continuous as invalid in the refined depth information.

In an embodiment, the method further includes assigning interpolated depth values to the segments having the texture-less tag with the sufficient number of matching points and continuous depth values of the matching points, and including the interpolated depth values in the refined depth information.

In an embodiment, the method further includes applying the depth values estimated from the observed points and the target points to perform obstacle detection in at least one of an autonomous navigation system or an advanced driver assistance system.

In an embodiment, the method further includes applying the depth values estimated from the observed points and the target points to perform scene reconstruction in an augmented reality or virtual reality system.

The depth estimation system and method provided herein integrate image segmentation, epipolar geometry, and hierarchical refinement to achieve robust and reliable depth estimation under multi-view or cross-sensor configurations. By constraining the correspondence search space through segment-level and pixel-level matching, the disclosed system effectively reduces computational complexity and minimizes mismatches. Furthermore, the distinctiveness-based refinement mechanism enhances depth completeness and consistency, ensuring that both texture-rich and texture-less regions are accurately represented in the resulting depth map. Through the combined use of semantic and geometric cues, the disclosed system enables stable performance even in challenging scenarios such as varying viewpoints, illumination conditions, or sensor modalities, making it particularly suitable for applications including autonomous navigation, obstacle detection, and scene reconstruction. Accordingly, the disclosed system and method provide a practical and extensible framework for achieving high-precision, high-robustness depth estimation in real-world environments.

### BRIEF DESCRIPTION OF THE DRAWINGS

The present disclosure can be more fully understood by reading the subsequent detailed description and examples with references made to the accompanying drawings, wherein:

FIG. 1 provides an example of an original scene image and its corresponding image segmentation map, according to an embodiment of the present disclosure;

FIG. 2 is a system architecture diagram of a depth estimation system, according to an embodiment of the present disclosure;

FIG. 3A illustrates the data flow of a depth estimation method, according to an embodiment of the present disclosure;

FIG. 3B illustrates the data flow of the depth computation pipeline, according to an embodiment of the present disclosure;

FIG. 4 illustrates an example of the implementation of the Segment-Level Matching step, according to an embodiment of the present disclosure;

FIG. 5 illustrates an example of the implementation of the Pixel-Level Matching step, according to an embodiment of the present disclosure;

FIG. 6 illustrates a detailed implementation of the Segment-Level Matching step, according to an embodiment of the present disclosure;

FIG. 7 illustrates an example of the implementation of the semantic category filter, according to an embodiment of the present disclosure;

FIG. 8 illustrates an example of the implementation of the appearance similarity filter, according to an embodiment of the present disclosure;

FIG. 9 is a flow diagram illustrating the detailed implementation of the BEV distance filter, according to an embodiment of the present disclosure;

FIG. 10 illustrates an example scenario of applying the BEV distance filter, according to an embodiment of the present disclosure;

FIG. 11 illustrates the advantage of the hierarchical matching strategy that performs segment-level matching prior to pixel-level matching, according to an embodiment of the present disclosure;

FIG. 12 illustrates the data flow of the generation of a depth map, according to an embodiment of the present disclosure; and

FIG. 13 illustrates a detailed implementation of the Depth Refinement step, according to an embodiment of the present disclosure.

### DETAILED DESCRIPTION

The following description is made for the purpose of illustrating the general principles of the disclosure and should not be taken in a limiting sense. The scope of the disclosure is best determined by reference to the appended claims.

In each of the following embodiments, the same reference numbers represent identical or similar elements or components.

Ordinal terms used in the claims, such as “first,” “second,” “third,” etc., are only for convenience of explanation, and do not imply any precedence relation between one another.

The descriptions provided below for embodiments of devices or systems are also applicable to embodiments of methods, and vice versa.

Provided herein is a depth estimation system that utilizes a semantic prior to enhance the accuracy and robustness of feature matching. Instead of performing pixel-level correspondence search over the entire image, the disclosed system first performs region-level or segment-level correspondence based on image segmentation. By determining corresponding object segments between multiple images, the system restricts the pixel-level matching process to a limited search space defined by the matched segments and an epipolar constraint. This hierarchical matching strategy aims to reduces the probability of mismatching, improves computational efficiency, and yields more stable and accurate depth estimation results even under large viewpoint differences.

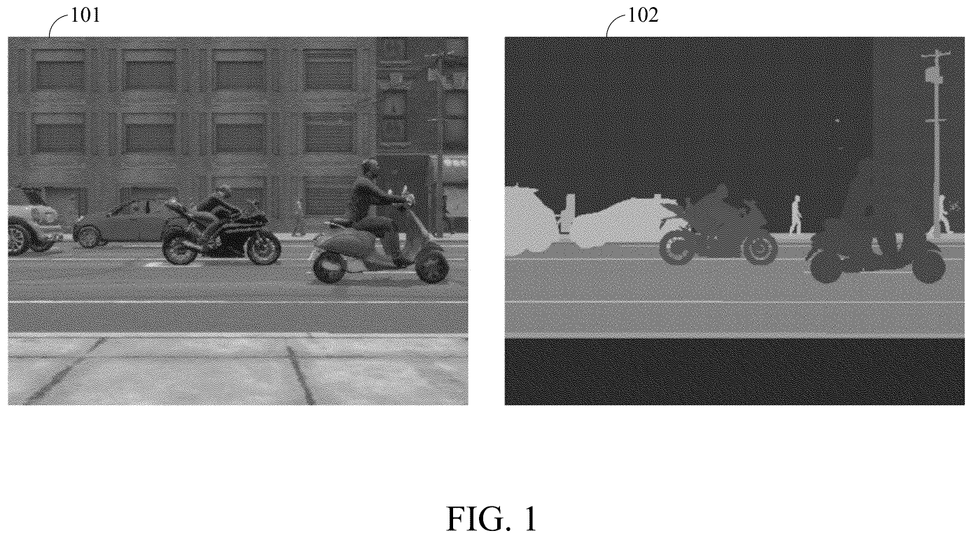

FIG. 1 provides an example of an original scene image 101 and its corresponding image segmentation map, according to an embodiment of the present disclosure. As shown in FIG. 1, the original scene image 101 includes multiple objects, such as vehicles and riders, appearing at different depths in a driving environment. The segmentation map 102 is generated from the original scene image 101 through an image segmentation process, in which pixels are classified into distinct object or region categories, such as road, vehicle, person, and building. In the segmentation map 102, each object category is represented as a visually distinct region, for example, by different colors or labels assigned to the corresponding pixel groups, thereby explicitly indicating the spatial extent of each object category. The segmentation map 102 provides such category-level information that enables subsequent depth estimation to be performed on a per-segment basis rather than over the entire image, thereby constraining the search space for pixel-level correspondence and improving the overall matching stability.

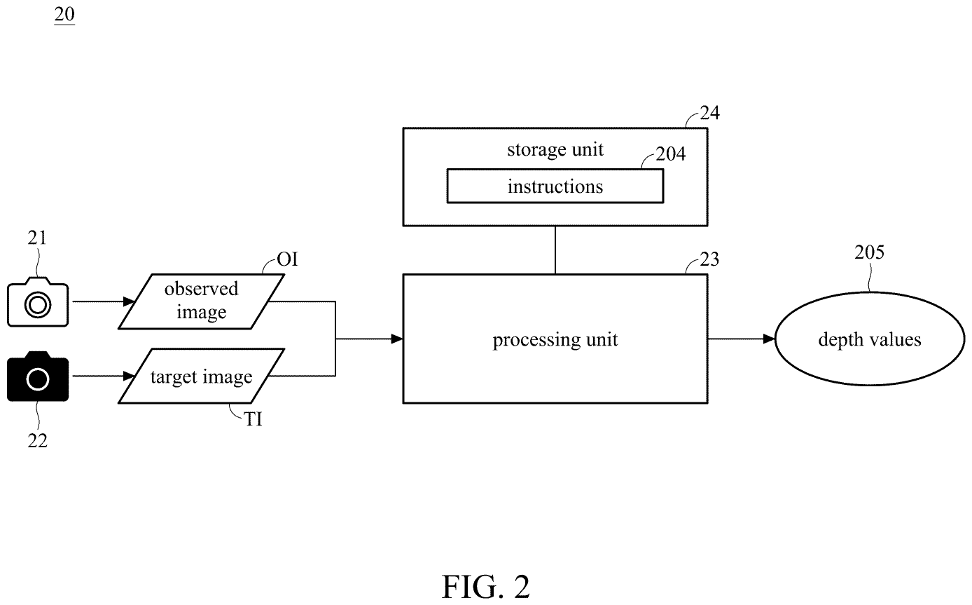

FIG. 2 is a system architecture diagram of a depth estimation system 20, according to an embodiment of the present disclosure. As shown in FIG. 2, the depth estimation system 20 includes two camera devices 21 and 22 (hereinafter referred to as a first camera device and a second camera device, respectively), a processing unit 23, and a storage unit 24.

The first camera device 21 and the second camera device 22 are image-capturing devices configured to acquire image data of a scene from different viewpoints. The first camera device 21 captures an observed image OI, and the second camera device 22 captures a target image TI. Each of the first camera device 21 and the second camera device 22 may be implemented as a pinhole camera, a fisheye camera, or any other type of optical or digital imaging sensor. The first camera device 21 and the second camera device 22 may be fixed at different positions or orientations so that the same object in the scene is captured under different perspectives, thereby enabling the derivation of depth information.

The processing unit 23 may be implemented as any suitable computing device or hardware circuit capable of performing arithmetic and logical operations, such as a central processing unit (CPU), a graphics processing unit (GPU), a neural processing unit (NPU), an Application-Specific Integrated Circuit (ASIC), a Field Programmable Gate Array (FPGA), a System on a Chip (SoC), or a combination thereof. The processing unit 23 may further include multiple processing cores or accelerators configured for parallel computation.

The storage unit 24 is coupled to processing unit 23, and may include one or more types of memory, such as a read-only memory (ROM), a random-access memory (RAM), or a non-volatile storage medium. The storage unit 24 stores instructions 204, which may be implemented in the form of software programs, executable code, or firmware written in any programming language, such as C, C++, or Python, but the present disclosure is not limited thereto. When the instructions 204 are executed by the processing unit 23, the processing unit 23 performs a depth estimation method disclosed herein to obtain one or more depth values 205 based on the observed image OI and the target image TI.

The processing unit 23 may obtain the observed image OI and the target image TI from the first camera device 21 and the second camera device 22 through any wired or wireless communication interface. Examples of such interfaces include, but are not limited to, Universal Serial Bus (USB), Peripheral Component Interconnect Express (PCIe), Gigabit Ethernet, or serial interfaces such as MIPI-CSI. In other embodiments, wireless transmission interfaces such as Wi-Fi, Bluetooth, or dedicated automotive communication buses. The selection of a particular communication interface may depend on system bandwidth, latency, and installation constraints, but the present disclosure is not limited thereto.

In an embodiment, the first camera device 21 is a pinhole camera, and the second camera device is a fisheye camera. The pinhole camera provides a relatively narrow field of view with low geometric distortion, thereby capturing the scene in a perspective close to the human visual perception and preserving accurate spatial proportions of objects. In contrast, the fisheye camera provides an ultra-wide field of view, typically exceeding 180 degrees, and captures peripheral areas that are not visible in the pinhole image, although the captured image exhibits noticeable geometric distortion. Due to these complementary characteristics, the observed image OI obtained from the pinhole camera offers high precision for objects in the forward direction, while the target image TI obtained from the fisheye camera covers a broader scene including side regions or objects appearing near the edges of the vehicle's field of view. Such a configuration is particularly advantageous in vehicular applications, for example, in an autonomous driving system, where combining the detailed perspective view and the wide-angle view allows the system to achieve more comprehensive depth estimation with improved robustness across different viewing angles.

In an embodiment, the processing unit 23 may further apply the estimated depth values 205 to perform obstacle detection in at least one of an autonomous navigation system or an advanced driver assistance system. By determining the relative distances between the vehicle and surrounding objects based on the depth values 205, the system can identify obstacles located within a predetermined safety range. Once an obstacle is detected, the autonomous navigation system may generate a collision risk map and determine an avoidance trajectory according to the spatial distribution of the depth values 205. Alternatively, the depth values 205 may be applied in an advanced driver assistance system to support functions including, but not limited to, lane-keeping, adaptive cruise control, and emergency braking, wherein the system evaluates obstacle proximity and trajectory feasibility to provide corrective steering or speed adjustments for enhanced driving safety.

The estimated depth values 205 can further be used to construct a drivable area map by distinguishing ground regions from elevated obstacles. Based on this information, the navigation system may dynamically adjust the vehicle's steering angle, acceleration, and braking parameters to ensure safe movement along a feasible path. Through the continuous acquisition and updating of depth values 205, the system is capable of performing real-time obstacle detection and path planning with enhanced precision and responsiveness.

In another embodiment, the processing unit 23 may further apply the estimated depth values 205 to perform scene reconstruction in an augmented reality (AR) or virtual reality (VR) system. In this embodiment, the estimated depth values 205 provides a three-dimensional representation of the surrounding environment, allowing virtual objects to be accurately placed and rendered with proper occlusion and scaling relative to real-world objects. Such scene reconstruction can enhance spatial realism and user immersion in AR or VR applications.

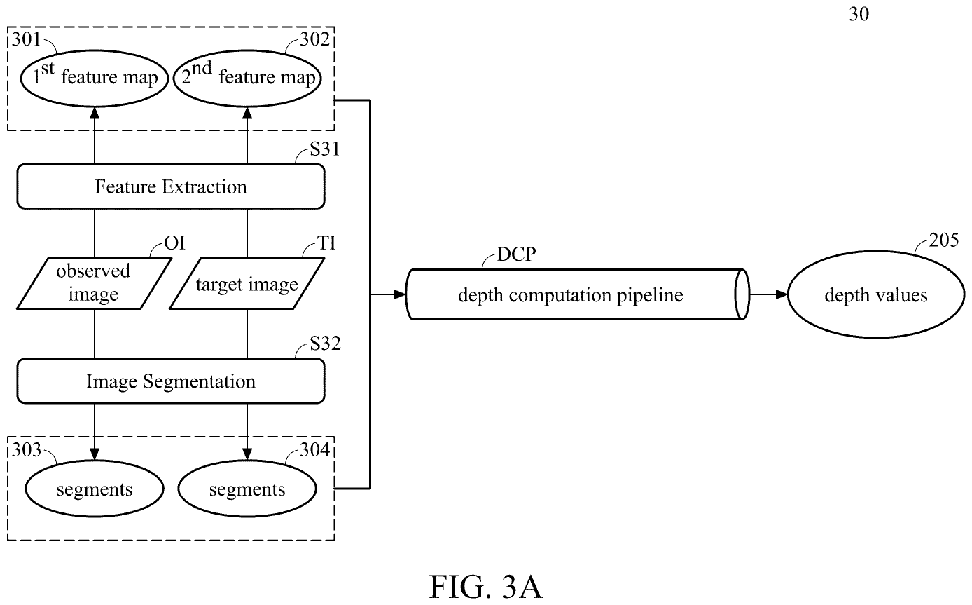

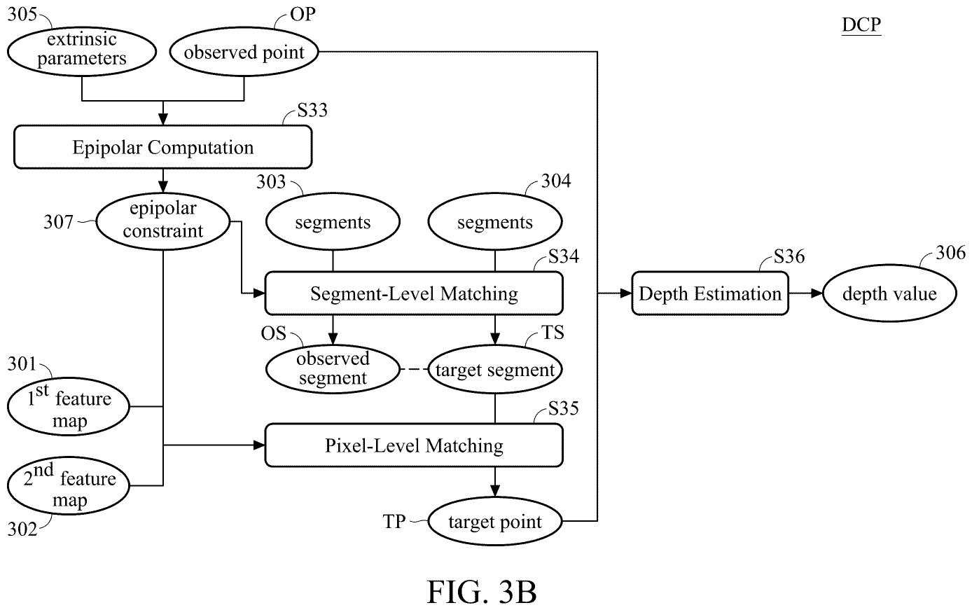

FIG. 3A illustrates the data flow of a depth estimation method 30 executed by the processing unit 23 in FIG. 2, according to an embodiment of the present disclosure. As shown in FIG. 3A, the depth estimation method includes a Feature Extraction step S31, an Image Segmentation step S32, and a depth computation pipeline DCP.

In the Feature Extraction step S31, a first feature map 301 and a second feature map 302 are generated through feature extraction based on the observed image OI and the target image TI, respectively.

The observed image OI and the target image TI respectively represent images captured from different viewpoints, such as by the first camera device 21 and the second camera device 22 shown in FIG. 2. The two images depict the same scene but exhibit discrepancies in scale, angle, and appearance due to the geometric relationship between the two cameras and their difference in specification.

Each of the feature maps 301 and 302 is a high-dimensional representation derived from the corresponding image, in which the raw pixel data are transformed into compact descriptors that encode local textures, edges, shapes, and other discriminative characteristics of the scene. The first feature map 301 corresponds to the observed image OI, and the second feature map 302 corresponds to the target image TI. These feature maps serve as reference data for subsequent correspondence search and depth computation.

The feature extraction may be implemented using various machine learning algorithms, such as a convolutional neural network (CNN), a transformer-based vision model, or a traditional hand-crafted feature extractor such as the scale-invariant feature transform (SIFT) or the histogram of oriented gradients (HOG). In a neural network implementation, multiple convolutional layers or attention modules may be used to learn hierarchical feature representations that are robust to illumination, rotation, and scale variations, but the present disclosure is not limited thereto.

In the Image Segmentation step S32, multiple segments 303 and 304 are identified from the observed image OI and the target image TI, respectively, through an image segmentation process. Each segment corresponds to a region of pixels sharing similar visual or statistical characteristics, such as color, texture, brightness, or edge continuity. In some implementations, the image segmentation may also produce regions that roughly align with meaningful objects or surfaces, such as vehicles, pedestrians, buildings, or road areas.

In data representation, the image segmentation process partitions the image into a plurality of labeled regions or indexed areas. Each pixel in the image can be associated with a segment identifier, thereby forming a segmentation map in which pixels having the same identifier belong to the same segment. For example, regions with different appearance or spatial attributes may be encoded using different indices or color codes. In practice, the segments 303 and 304 can be stored as index maps or label matrices, where each pixel value indicates the segment ID or classification label to which the pixel belongs.

The image segmentation process may be implemented using a variety of algorithms. In one embodiment, a deep learning-based segmentation network may perform pixel-wise classification or instance-level delineation on the input image. Examples include convolutional or transformer-based models that generate semantic segmentation outputs where each pixel is assigned a category label such as “vehicle” or “pedestrian”, or instance segmentation outputs where each individual object instance within the same category is assigned a unique identifier. In another embodiment, classical clustering-based or graph-based approaches, such as mean-shift segmentation or region merging, may be used to partition the image into coherent regions based on similarity in visual features such as color, texture, or spatial continuity.

In general, the term “image segmentation” as used herein broadly refers to any technique for partitioning an image into coherent regions, including but not limited to semantic segmentation, instance segmentation, or unsupervised region-based segmentation. Such techniques may incorporate edge-preserving region delineation, multi-scale feature encoding, or cross-sensor feature correlation to ensure stable performance across diverse environments and camera configurations. The resulting segmentation output defines visually or semantically coherent image regions that provide region-level priors for the subsequent matching and depth estimation processes. These segmentation results may be represented as label matrices or index maps, where pixel values indicate either a category label or, in the case of instance-level segmentation, a unique segment identifier.

The Feature Extraction step S31 and the Image Segmentation step S32 described above provide the reference basis for subsequent processing in the depth computation pipeline (DCP). The reference information includes the first feature map 301, the second feature map 302, and the segments 303 and 304 derived from the observed image OI and the target image TI, respectively. These data serve as complementary cues that jointly facilitate accurate correspondence search and depth inference. Hereinafter, the operation of the depth computation pipeline DCP will be described in detail with reference to FIG. 3B, illustrating how the depth computation pipeline DCP estimates the depth values 205 based on the above-mentioned feature maps and segments.

FIG. 3B illustrates the data flow of the depth computation pipeline DCP, according to an embodiment of the present disclosure. As shown in FIG. 3B, the depth computation pipeline DCP includes an Epipolar Computation step S33, a Segment-Level Matching step S34, a Pixel-Level Matching step S35, and a Depth Estimation step S36. These steps are executed for each observed point OP in the observed image OI to estimate a corresponding depth value 306. As used herein, the observed point OP refers to a pixel location selected from the observed image OI, and is located within an observed segment OS, which is one of the segments identified in the observed image through image segmentation. The processing unit 23 may iteratively perform the DCP for multiple observed points across the observed image OI, thereby generating a plurality of depth value 306 that collectively form the depth values 205 described in FIG. 3A.

The observed point OP represents a pixel location in the observed image OI for which depth information is to be inferred. Depending on the application, the observed points may be selected in different manners. In a dense stereo estimation task, substantially all pixels in the observed image OI may be treated as observed points. In contrast, in a sparse depth estimation or feature-based application, only a subset of pixels, such as corner features, edge points, or regions of interest, may be selected as observed points. For example, in an autonomous driving scenario, observed points may correspond to detected obstacles or lane markings, while in an augmented reality system, they may correspond to key visual anchors used for spatial alignment.

In the Epipolar Computation step S33, the processing unit 23 computes an epipolar constraint 307 corresponding to the observed point OP based on extrinsic parameters 305 of the camera devices, such as the first camera device 21 and the second camera device 22 illustrated in FIG. 2.

The extrinsic parameters 305 define the relative pose between the two cameras, which allows the system to geometrically relate a point in the observed image OI to a corresponding epipolar line in the target image TI. Specifically, the extrinsic parameters 305 may include a rotation matrix and a translation vector describing the transformation from the coordinate system of the first camera device 21 to that of the second camera device 22. In some implementations, these parameters can be obtained through a one-time calibration procedure or updated dynamically based on vehicle motion data or inertial measurement units (IMUs). The accuracy of the extrinsic parameters directly affects the precision of the computed epipolar constraint and, consequently, the correctness of point matching across the two images.

Epipolar constraint is a geometric property that establishes a relationship between corresponding points in two images captured by cameras with different viewpoints. It reduces the search space for pixel matching by imposing a restriction that corresponding points must lie along specific paths defined by the cameras'relative positioning. Specifically, the epipolar constraint 307 describes the geometric relationship between the observed point OP in the observed image OI and its potential corresponding point (hereinafter referred to as “target point”) in the target image TI. The epipolar constraint 307 can be defined by a coefficient set of an epipolar line, such as (a, b, c) for the straight line equation ax+by+c=0. The target point in the target image TI must lie on or near this epipolar line determined by the camera geometry. This constraint serves as a geometric prior for the subsequent segment-level and pixel-level matching steps.

In the Segment-Level Matching step S34, the processing unit 23 determines the corresponding region of the target image TI in which a matching relationship with the observed point OP is to be searched. Specifically, the processing unit 23 first identifies, among the multiple segments 303 in the observed image OI, an observed segment OS that contains the observed point OP. The observed segment OS represents a semantic or spatially coherent region surrounding the observed point, within which pixels are likely to share similar depth or visual characteristics.

Subsequently, the processing unit 23 determines, among the multiple segments 304 in the target image TI, a target segment TS that corresponds to the observed segment OS. The determination of the target segment TS is guided by the epipolar constraint 307 derived in the previous step (i.e., Epipolar Computation step S33), so that only the segments intersecting the corresponding epipolar line in the target image TI are considered as candidates. The Segment-Level Matching step S34 therefore provides a region-level correspondence framework, which serves as a spatial constraint for the subsequent Pixel-Level Matching step S35.

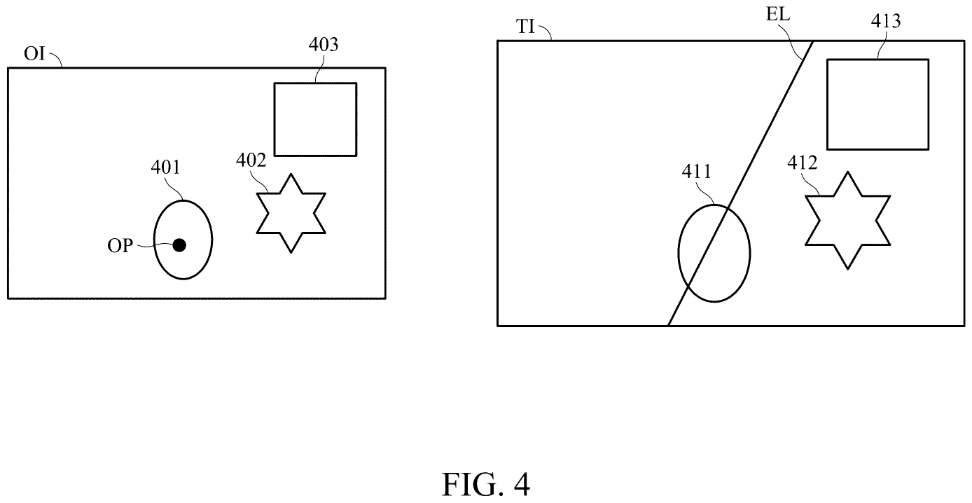

FIG. 4 illustrates an example of the implementation of the Segment-Level Matching step S34, according to an embodiment of the present disclosure. As shown in FIG. 4, the observed image OI includes multiple segments, such as an elliptical segment 401, a star-shaped segment 402, and a square segment 403. The observed point OP is located within the elliptical segment 401. The target image TI also includes corresponding segments 411, 412, and 413, which respectively represent regions of the same or similar semantic categories as those in the observed image OI, but are captured from a different camera viewpoint.

In the illustrated example, the processing unit 23 first identifies the elliptical segment 401 as the observed segment OS that contains the observed point OP. Then, under the restriction of the epipolar constraint defined by the epipolar line EL indicating the possible locations of pixels that could correspond to the observed point OP, the processing unit 23 searches within the target image TI for one or more candidate segments that intersect the epipolar line EL. In this example, the segment 411 is determined as the target segment TS, because it is the only segment that intersects the epipolar line EL.

Refer back to FIG. 3B. In the Pixel-Level Matching step S35, the processing unit 23 searches, within the target segment TS determined in the previous step (i.e., Segment-Level Matching step S34), for a target point TP corresponding to the observed point OP. In this step, the search is conducted under the restriction of the epipolar constraint 307, such that the potential target point TP must lie on or near the epipolar line associated with the observed point OP.

The matching evaluation between the observed point OP and the target point TP is performed based on the feature information contained in the first feature map 301 and the second feature map 302. In particular, the processing unit 23 compares the feature descriptor at the observed point OP with those of pixels along the epipolar line within the target segment TS, to identify the pixel exhibiting the highest similarity or the minimum matching cost as the target point TP.

By constraining the pixel-level search to the geometrically valid region (defined by the epipolar constraint 307) and the semantically relevant region (defined by the segment-level matching result), the system achieves accurate and robust correspondence between the observed image OI and the target image TI. The obtained correspondence between the observed point OP and the target point TP serves as the basis for the subsequent Depth Estimation step S36.

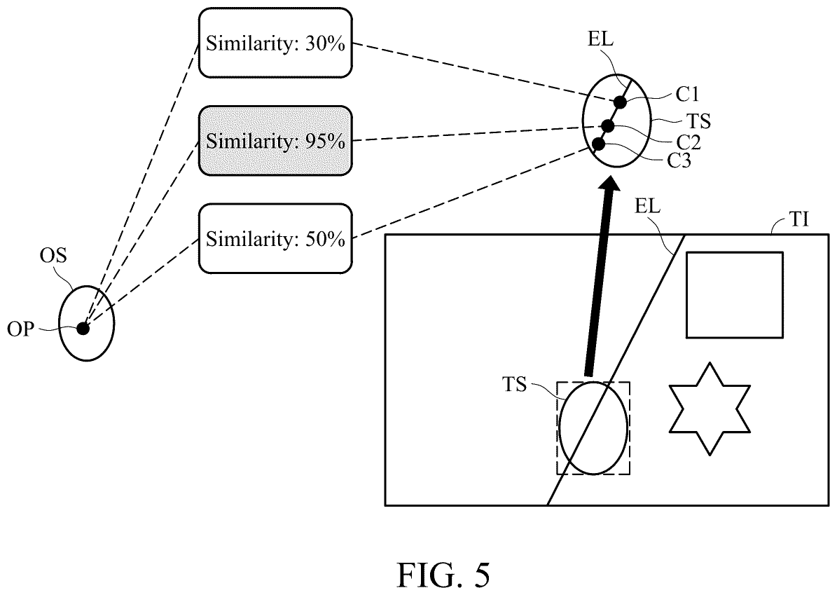

FIG. 5 illustrates an example of the implementation of the Pixel-Level Matching step S35, according to an embodiment of the present disclosure. As shown in FIG. 5, the observed point OP is located within the observed segment OS in the observed image OI, and its corresponding target segment TS in the target image TI has been determined through the Segment-Level Matching step S34. Within the target segment TS, several candidate points such as C1-C3 are identified along the epipolar line EL.

For each candidate point, the processing unit 23 compares its local feature descriptor derived from the second feature map 302 with the feature descriptor of the observed point OP derived from the first feature map 301. A similarity value is computed for each comparison, representing how likely each candidate point corresponds to the same physical point observed by the two cameras. As illustrated in FIG. 5, the candidate points C1-C3 yield similarity values of 30%, 95%, and 50%, respectively. The processing unit 23 selects the candidate point with the highest similarity (in this case, C2) as the target point TP corresponding to the observed point OP.

Refer back to FIG. 3B. In the Depth Estimation step S36, the processing unit 23 estimates a depth value 306 for the observed point OP based on the correspondence established with the target point TP. The disparity between the observed point OP in the observed image OI and the target point TP in the target image TI is computed according to their pixel coordinates. The disparity represents the apparent displacement of the same physical point in two camera views, which is inversely related to the actual depth of the point relative to the cameras.

In some implementations, the processing unit 23 uses the known extrinsic parameters 305 and intrinsic calibration parameters of the first and second camera devices to transforms the pixel disparity into the depth value 306. This process can be implemented using geometric triangulation or equivalent projection-based depth computation models. In further implementations, the Depth Estimation step S36 may further incorporate local confidence weighting or feature-based consistency checking to refine the resulting depth accuracy.

Through iterative execution of the Depth Estimation step S36 for multiple observed points OP across the observed image OI, a collection of depth values 306 is obtained, forming the depth values 205 illustrated in FIG. 3A.

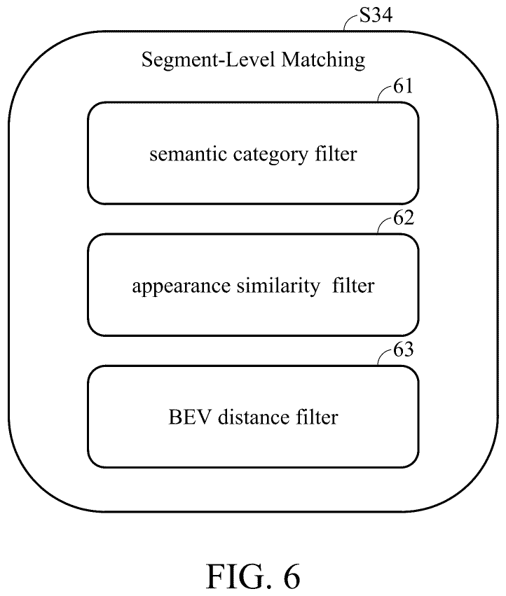

FIG. 6 illustrates a detailed implementation of the Segment-Level Matching step S34, according to an embodiment of the present disclosure. As described above, in the Segment-Level Matching step S34, the processing unit 23 determines, among the multiple segments in the target image TI, one or more candidate segments based on the epipolar constraint. To further refine the candidate segments and accurately determine the target segment TS, the processing unit 23 may apply one or more filtering processes, such as a semantic category filter 61, an appearance similarity filter 62, and a BEV (bird's-eye view) distance filter 63. Each of these filters can be selectively or jointly applied depending on the application requirements and the characteristics of the input data. Moreover, the order in which the filters are executed is not limited herein, and may be adjusted dynamically or in parallel to improve computational efficiency or robustness.

The semantic category filter 61 filters the candidate segments in the target image TI by comparing their semantic labels with that of the observed segment OS. Specifically, only the candidate segments having a semantic category identical to that of the observed segment are retained as potential matches. This filtering step effectively removes semantically irrelevant regions that may otherwise lead to false correspondences, thereby reducing the search space and improving the matching accuracy. The semantic labels used for filtering may be derived from the results of the Image Segmentation step S32, as illustrated in FIG. 3A.

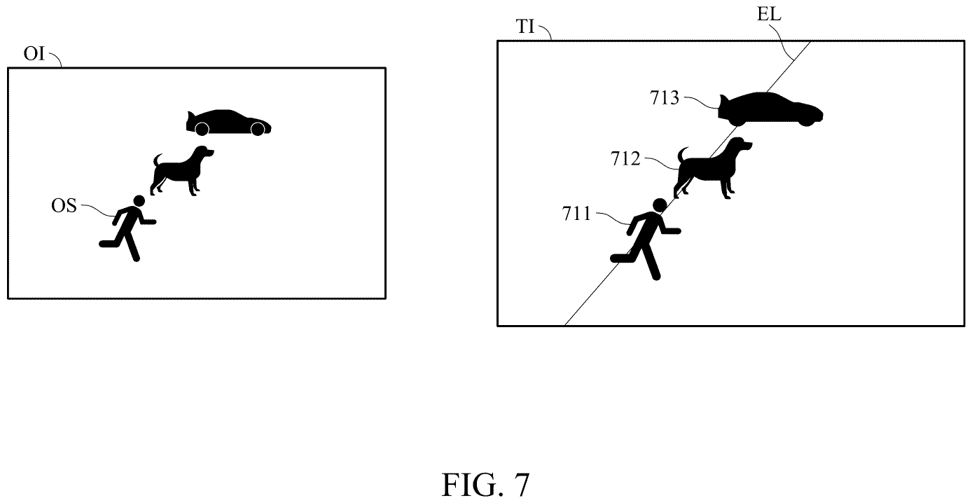

FIG. 7 illustrates an example of the implementation of the semantic category filter 61, according to an embodiment of the present disclosure. As shown in FIG. 7, the observed image OI includes an observed segment OS corresponding to a “pedestrian,” while the target image TI includes multiple segments 711, 712, and 713 intersecting the epipolar line EL. In the illustrated example, the segments 711, 712, and 713 are respectively labeled as “pedestrian,” “dog,” and “vehicle” according to the segmentation results obtained in the Image Segmentation step S32.

When applying the semantic category filter 61, the processing unit 23 selects only those candidate segments in the target image TI whose semantic category matches that of the observed segment OS. In the illustrated example, because the observed segment OS is labeled as “pedestrian,” only the segment 711 in the target image TI satisfies this condition and is retained as a valid candidate, while the other segments 712 and 713 are excluded from further consideration.

The appearance similarity filter 62 refines the candidate segments in the target image TI by evaluating the degree of visual resemblance between each candidate segment and the observed segment OS. Specifically, the processing unit 23 computes an appearance similarity measure for each candidate segment based on the feature values extracted in the Feature Extraction step S31, such as shape, color, texture, gradient distribution, or high-dimensional embeddings derived through feature extraction.

Among the candidate segments, only those whose appearance similarity to the observed segment OS exceeds a predetermined similarity threshold are retained as valid matches, while the others are excluded. The similarity threshold may be adaptively determined based on statistical characteristics of the feature maps or empirically set according to the application scenario.

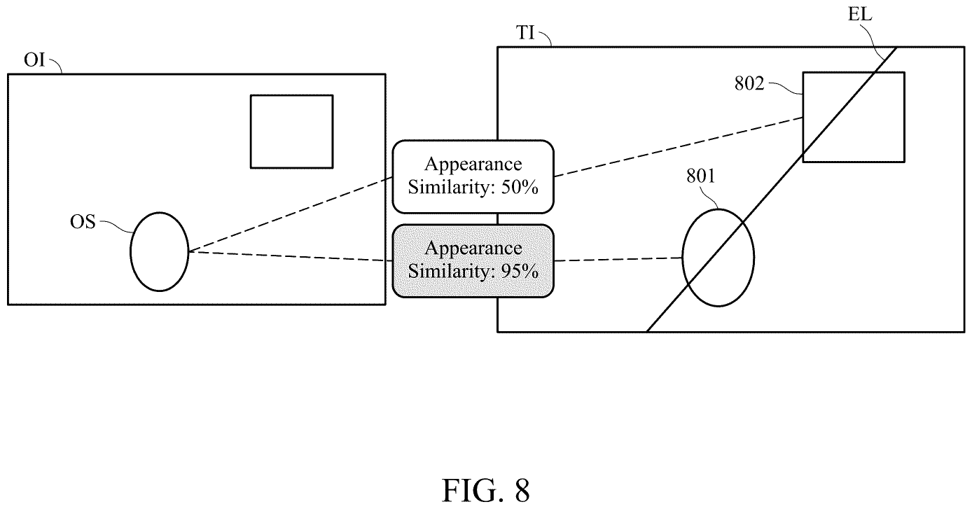

FIG. 8 illustrates an example of the implementation of the appearance similarity filter 62, according to an embodiment of the present disclosure. As shown in FIG. 8, the observed image OI includes an observed segment OS, and the target image TI includes two candidate segments 801 and 802 intersecting the epipolar line EL. The processing unit 23 compares the appearance features of each candidate segment with those of the observed segment OS and computes respective similarity values.

In the illustrated example, the candidate segment 801 exhibits an appearance similarity of 95% with the observed segment OS, while the candidate segment 802 exhibits a similarity of only 50%. Consequently, the candidate segment 801 is selected as the target segment TS. Through this process, the appearance similarity filter 62 effectively eliminates visually inconsistent regions that may have the same semantic category but different visual characteristics, thereby enhancing the accuracy of region-level correspondence.

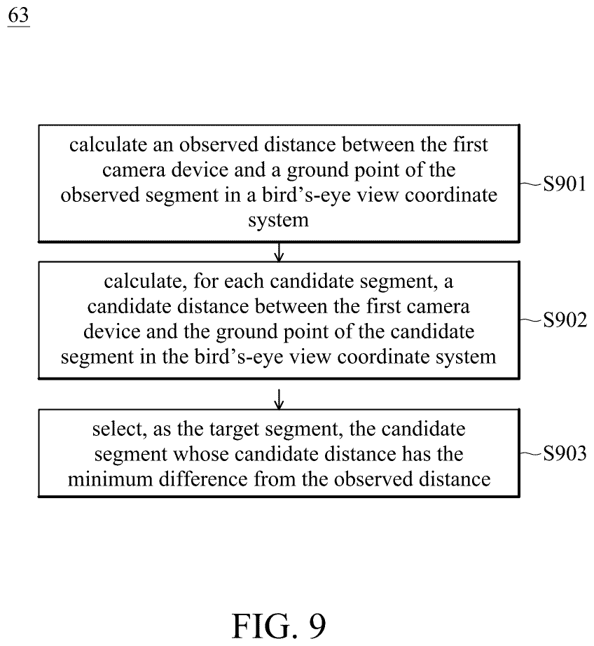

FIG. 9 is a flow diagram illustrating the detailed implementation of the BEV distance filter 63, according to an embodiment of the present disclosure. As shown in FIG. 9, the BEV distance filter 63 may include steps S901-S903, each of which is elaborated below.

In step S901, an observed distance between the first camera device and a ground point of the observed segment is calculated in a bird's-eye-view (BEV) coordinate system. The BEV coordinate system represents a top-down spatial reference frame in which the positions of objects are expressed with respect to the ground plane. The ground point of the observed segment may be defined as a representative point of contact between the observed object and the ground, serving as a geometric reference for distance comparison.

In practice, the computation of the observed distance may be achieved either by first identifying the ground point of the observed segment in the original image and then projecting it to the BEV coordinate system, or by first projecting the entire observed segment into the BEV coordinate system and subsequently determining the ground point within the projected region. The present disclosure is not limited to any particular order or implementation strategy.

In step S902, for each candidate segment in the target image, a candidate distance between the first camera device and the ground point of the candidate segment is calculated in the BEV coordinate system. Similar to step S901, the calculation may be performed either by first identifying the ground point and then projecting it to the BEV coordinate system, or by projecting the entire candidate segment and subsequently determining its ground point in the BEV plane.

By expressing both the observed distance and the candidate distances in the same BEV coordinate system, geometric distortions caused by camera perspective or different orientations are mitigated, allowing the relative positions of segments in different images to be compared more consistently.

In step S903, the processing unit 23 selects, as the target segment, the candidate segment whose candidate distance exhibits the minimum difference from the observed distance. The minimum difference represents the smallest positional discrepancy between the corresponding ground points of the observed segment and the candidate segment in the BEV coordinate system, thereby implying the highest likelihood of geometric correspondence between the two.

The selection criterion of the BEV distance filter 63 ensures that the final target segment TS is not only consistent with the epipolar constraint but also geometrically aligned with the observed segment in real-world space. Even when multiple candidate segments share the same semantic category and exhibit similar visual appearance, the BEV distance filter 63 can further discriminate among them based on their relative ground distances. This enables the system to exclude false matches that are semantically or visually similar but located at significantly different spatial positions, thereby enhancing the overall reliability and geometric precision of the segment-level matching process under multi-view or cross-sensor configurations.

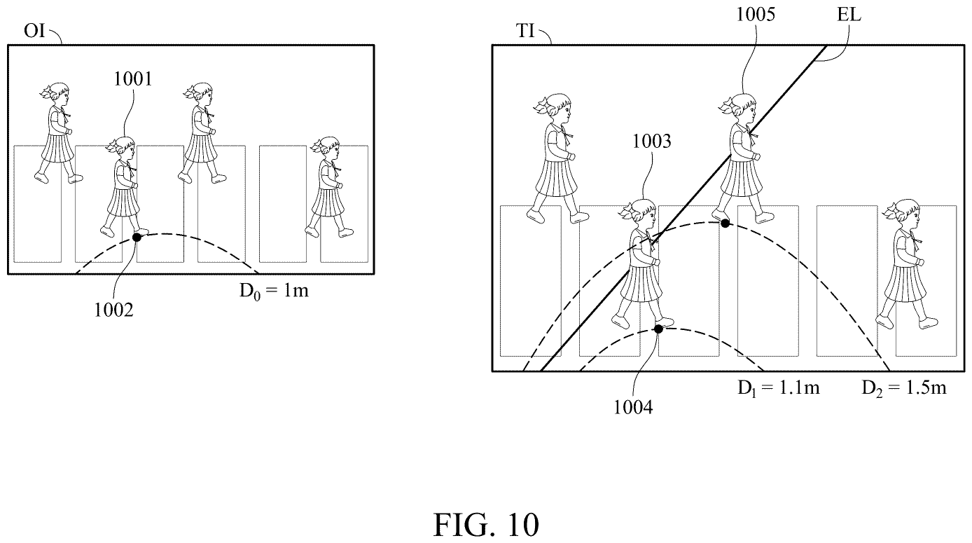

FIG. 10 illustrates an example scenario of applying the BEV distance filter 63, according to an embodiment of the present disclosure. As shown in FIG. 10, the observed image OI and the target image TI respectively capture several students 1001, 1003, 1005 walking across a pedestrian crossing. Since the students are wearing identical uniforms and have similar body shapes, their visual appearances are highly alike, making it difficult to distinguish them using the semantic category filter 61 or the appearance similarity filter 62 alone.

Each student corresponds to a ground point that represents the location where the student's feet contact the ground, denoted as 1002 in the observed image OI and 1004 in the target image TI. The observed distance Dₒ between the first camera device and the ground point 1002 is calculated in the bird's-eye-view coordinate system, as shown by the dashed arc beneath the observed image OI. Similarly, the target image TI contains multiple candidate segments with corresponding ground points (e.g., 1004 and 1006) and respective BEV distances D₁ and D₂ from the camera device.

In this example, both segments of the students 1003 and 1005 lie along the same epipolar line EL and share similar semantic and visual characteristics with the observed section of the student 1001. However, the BEV distance filter 63 selects the candidate segment corresponding to D₁=1.1 m, which has the smallest difference from the observed distance Dₒ=1 m, as the correct target segment. This illustrates how the BEV distance filter 63 can effectively disambiguate between geometrically distinct yet visually similar objects, ensuring accurate correspondence even in challenging real-world scenes such as pedestrian crossings or dense traffic environments.

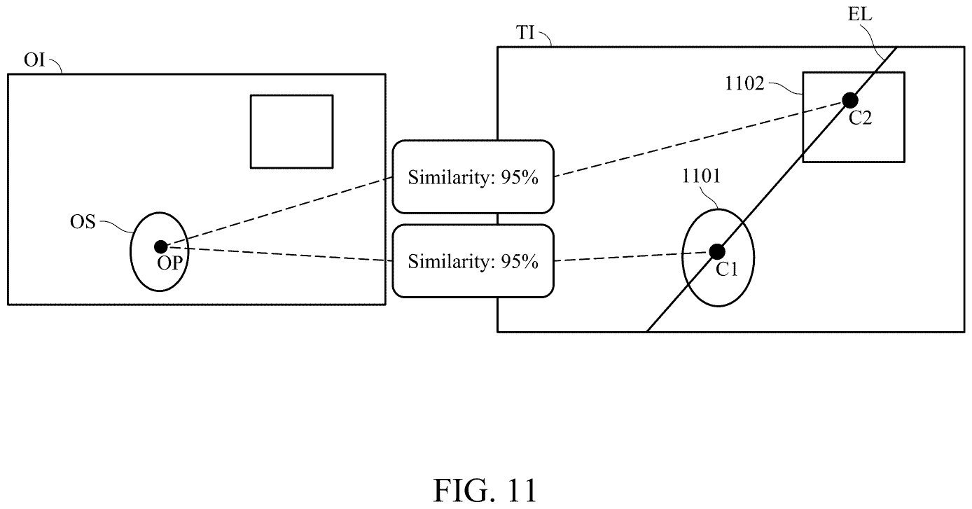

FIG. 11 illustrates the advantage of the hierarchical matching strategy that performs segment-level matching prior to pixel-level matching, according to an embodiment of the present disclosure. As shown in FIG. 11, the observed image OI includes an observed segment OS containing the observed point OP, while the target image TI includes multiple candidate points C1 and C2 distributed along the corresponding epipolar line EL. In this example, both candidate points C1 and C2 exhibit nearly identical feature similarity scores (e.g., 95%) with respect to the observed point OP, making them indistinguishable in a conventional pixel-level matching process that relies solely on local feature comparison.

However, under the hierarchical matching strategy disclosed herein, the search space for pixel-level matching is first restricted to the segment 1101 (i.e., the target segment) determined in the preceding segment-level matching step. Consequently, only candidate points within this target segment (e.g., C1) are evaluated, while points in unrelated segments (e.g., C2 within segment 1102) are excluded from the matching process.

This hierarchical matching approach not only reduces the computational complexity by narrowing the search space along the epipolar line but also significantly enhances the robustness of the matching results by ensuring geometric and semantic consistency across corresponding image regions. As a result, mismatches due to visually similar but contextually distinct points can be effectively prevented, leading to more accurate and stable depth estimation outcomes.

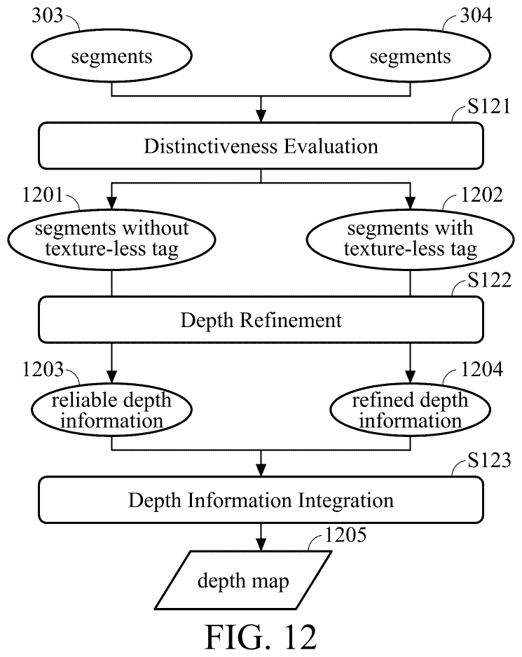

In an embodiment, after the depth values 205 of individual observed points have been estimated through the depth computation pipeline DCP, the processing unit 23 may further refine these depth values and integrate them into a complete and consistent depth map. Such refinement compensates for unreliable or missing depth estimations that often occur in texture-less or low-feature regions, thereby improving the overall quality of depth perception. The refined and integrated depth information can thus represent a dense and geometrically coherent depth map suitable for subsequent perception or reconstruction tasks. The following description, with reference to FIG. 12, provides details of these additional processing steps.

FIG. 12 illustrates the data flow of the generation of a depth map 1205, according to an embodiment of the present disclosure. As shown in FIG. 12, additional steps including a Distinctiveness Evaluation step S121, a Depth Refinement step S122, and a Depth Information Integration step S123 may be executed by the processing unit 23 to generate the depth map 1205. Each of these steps is elaborated below. These improvements operates on the depth values 205 generated by the depth computation pipeline (DCP) described in FIG. 3A, together with the segments identified in the observed image and the target image. Both sets of segments undergo distinctiveness evaluation in step S121 to determine whether they are texture-less

In the Distinctiveness Evaluation step S121, the processing unit 23 evaluates a distinctiveness score for each of the multiple segments 303 and 304 in the observed image OI and the target image TI, and assigns a texture-less tag to those segments whose distinctiveness score is lower than a predefined distinctiveness threshold. The distinctiveness score represents a quantitative measure of the degree of local variation or visual richness within a segment, which reflects how easily features in that region can be uniquely matched between the two views.

Segments with high distinctiveness scores typically correspond to regions with strong texture or well-defined visual structures, such as vehicle bodies, building facades, or traffic signs, where local features can be reliably detected and matched. In contrast, segments with low distinctiveness scores often correspond to texture-less or uniform regions, such as paved roads, sky areas, or walls with minimal contrast, which provide insufficient cues for feature correspondence.

As a result, the processing unit 23 classifies the segments into two groups: segments 1201 without a texture-less tag (i.e., texture-rich or feature-distinct regions) and segments 1202 with a texture-less tag (i.e., texture-less or low-feature regions), as shown in FIG. 12.

In an embodiment, the distinctiveness score of each segment may be calculated based on a variance of feature values within that segment. The feature values can be derived from at least one of the first feature map 301 and the second feature map 302. The variance of feature values quantifies the degree of dispersion of local feature responses within a segment. A higher variance indicates greater heterogeneity of local features, meaning the segment contains diverse patterns or textures, therefore yielding a higher distinctiveness score. Conversely, a lower variance implies that the segment exhibits little internal variation, suggesting that it is texture-less and prone to ambiguity during correspondence estimation. Accordingly, segments with variance below the distinctiveness threshold are labeled with the texture-less tag for subsequent refinement.

In the Depth Refinement step S122, the processing unit 23 generates reliable depth information 1203 directly from the depth values estimated for the segments 1201 without the texture-less tag, while refining the depth values of the segments 1202 with the texture-less tag to obtain refined depth information 1204. In this step, segments 1201 without the texture-less tag contribute reliable depth information 1203, while segments 1202 with the texture-less tag are processed through interpolation or validation to produce refined depth information 1204.

This distinction arises from the differing confidence levels associated with the two segment types. The segments 1201 without the texture-less tag generally provide robust feature correspondence and yield depth values that are considered reliable without further adjustment. In contrast, the segments 1202 with the texture-less tag correspond to regions where texture deficiency or visual uniformity may cause matching uncertainty or sparse valid correspondences. Therefore, additional refinement is applied to the segments 1202 with the texture-less tag to improve the completeness and smoothness of their depth values before integration.

In the Depth Information Integration step S123, the processing unit 23 integrates the reliable depth information 1203 and the refined depth information 1204 to generate a complete depth map 1205. The integration process ensures that both types of depth information are spatially aligned and seamlessly combined, resulting in a dense and continuous depth representation that covers the entire image domain. The final depth map 1205 thus provides accurate geometric information across both texture-rich and texture-less regions, enabling stable downstream processing such as object detection, scene reconstruction, and path planning.

In an embodiment, for each of the segments 1202 with texture-less tag, the processing unit 23 determines whether the segment contains a sufficient number of matching points. The “matching points” refer to the pixel correspondences successfully established between the observed image and the target image within that segment. A sufficient number of such points indicates that the segment has adequate geometric evidence to support a meaningful depth estimation. If the number of matching points within a segment is below a predetermined sufficiency threshold, the processing unit 23 marks the corresponding depth values of that segment as invalid in the refined depth information 1204. This mechanism prevents unreliable or noise-dominated regions from introducing errors into the final depth map 1205 and helps maintain the structural consistency of the overall depth estimation.

In an embodiment, for each of the segments 1202 having the texture-less tag and containing a sufficient number of matching points, the processing unit 23 further determines whether the depth values of those matching points are continuous within that segment. The continuity evaluation examines whether the depth values exhibit a spatially coherent pattern consistent with the physical geometry of the observed object or surface. If the depth values of matching points within a segment are found to be non-continuous, such as exhibiting abrupt jumps or irregular disparities, the processing unit 23 marks the depth values of that segment as invalid in the refined depth information. This mechanism prevents discontinuous or geometrically inconsistent estimations from impacting the reliability of the depth map 1205.

In an embodiment, for the segments having the texture-less tag that both contain a sufficient number of matching points and exhibit continuous depth values of the matching points, the processing unit 23 assigns interpolated depth values to these segments and includes the interpolated depth values in the refined depth information 1204. The interpolation process estimates plausible depth distributions within such texture-less regions based on the surrounding valid depth values, enforcing smooth transitions while preserving consistency with neighboring segments. By doing so, the refined depth information provides dense and visually coherent depth estimates even for areas where direct feature correspondence is sparse or unreliable.

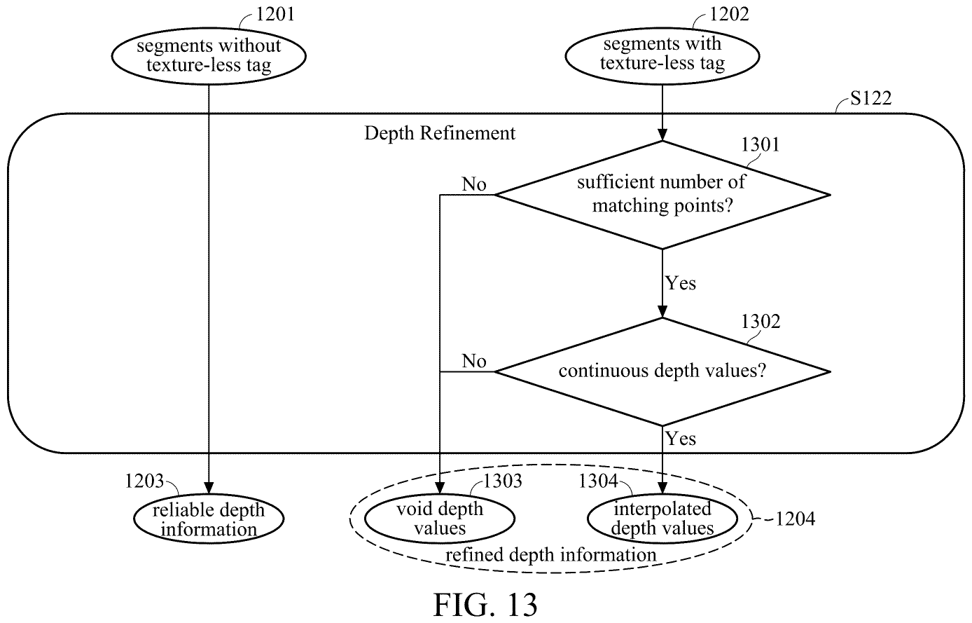

FIG. 13 illustrates a detailed implementation of the Depth Refinement step S122, according to an embodiment of the present disclosure. As shown in FIG. 13, the Depth Refinement step S122 refines the depth information of the segments 1202 with the texture-less tag based on a sequence of conditional evaluations. Two primary conditions, condition 1301 and condition 1302, are applied to determine the reliability and continuity of the depth estimations for each segment.

Specifically, condition 1301 evaluates whether a given segment with the texture-less tag contains a sufficient number of matching points. If the number of valid matches does not reach the sufficiency threshold, the corresponding depth values are classified as void depth values 1303 in the refined depth information 1204, indicating that the segment lacks adequate correspondence evidence to support meaningful depth estimation. Conversely, when condition 1301 is satisfied, the process proceeds to condition 1302.

Condition 1302 determines whether the depth values of the matching points within the segment exhibit continuity. When the depth values are spatially coherent and show smooth variation across the segment, interpolated depth values 1304 are generated to complete the refined depth information 1204. Otherwise, when the depth values are non-continuous, suggesting local disparity inconsistency or possible mismatches, the segment is again assigned void depth values 1303 to avoid contaminating the subsequent Depth Information Integration step S123.

Meanwhile, the segments 1201 without the texture-less tag directly provide reliable depth information 1203 derived from their estimated depth values. Together, the reliable depth information 1203 and the refined depth information 1204 (which include both void depth values 1303 and interpolated depth values 1304) form a comprehensive input set for the subsequent Depth Information Integration step S123. This hierarchical refinement process ensures that texture-rich, texture-less, and uncertain regions are all properly represented, thereby enhancing the density and reliability of the final depth map 1205.

The depth estimation system and method provided herein integrate image segmentation, epipolar geometry, and hierarchical refinement to achieve robust and reliable depth estimation under multi-view or cross-sensor configurations. By constraining the correspondence search space through segment-level and pixel-level matching, the disclosed system effectively reduces computational complexity and minimizes mismatches. Furthermore, the distinctiveness-based refinement mechanism enhances depth completeness and consistency, ensuring that both texture-rich and texture-less regions are accurately represented in the resulting depth map. Through the combined use of semantic and geometric cues, the disclosed system enables stable performance even in challenging scenarios such as varying viewpoints, illumination conditions, or sensor modalities, making it particularly suitable for applications including autonomous navigation, obstacle detection, and scene reconstruction. Accordingly, the disclosed system and method provide a practical and extensible framework for achieving high-precision, high-robustness depth estimation in real-world environments.

In some embodiments, the depth estimation system 20 may dynamically adjust its segment selection and pixel matching behavior based on the characteristics of the input images and the operational context. For example, the processing unit 23 may prioritize candidate segments that intersect the epipolar line and exhibit high semantic and appearance similarity to the observed segment, while also minimizing geometric deviation in bird's-eye-view coordinates. This multi-factor selection policy enables the system to reduce false matches and improve depth accuracy, particularly in scenes with ambiguous or texture-less regions.

The depth estimation system 20 may further refine depth values by evaluating the distinctiveness of each segment using feature variance, and by applying conditional rules based on match sufficiency and depth continuity. Segments failing to meet these criteria may be marked as invalid or assigned interpolated depth values, depending on the context. In this regard, the term “matching point” refers to a pixel in the target image that corresponds to an observed point in the observed image, determined through feature similarity constrained by epipolar geometry and segment-level gating. The term “invalid” depth values refers to pixel-level or segment-level depth estimates that are excluded from integration due to insufficient matching evidence or discontinuity, but do not imply that the entire depth map 1205 is unusable. The term “continuous” depth values refers to a spatially coherent set of depth estimates within a segment, exhibiting smooth variation without abrupt disparity changes.

The filtering steps may be executed in parallel or in a dynamically adjusted order, depending on resource constraints or input variability. Intermediate results such as the first feature map 301, the second feature map 302, and the segments 303, 304, or 1201 may be reused across iterations to reduce computational overhead. The term “appearance similarity” refers to a computed similarity score between segments based on aggregated feature descriptors from the feature maps 301 and 302, such as cosine similarity or L2 norm. The term “semantic category identical” means that the observed and candidate segments share the same label assigned by the image segmentation process, such as ‘vehicle’, ‘pedestrian’, or ‘road’, based on a common taxonomy. The term “minimum difference” in BEV distance refers to the smallest absolute value of the difference between the observed distance and candidate distance in the bird's-eye-view coordinate system, calculated from ground point projections. The system may also support auxiliary functions such as obstacle detection or scene reconstruction, which consume the refined depth map 1205 without altering the core estimation pipeline. These behaviors collectively enable the system to operate efficiently across diverse sensor configurations and environmental conditions.

The above paragraphs are described with multiple aspects. Obviously, the teachings of the specification may be performed in multiple ways. Any specific structure or function disclosed in examples is only a representative situation. According to the teachings of the specification, it should be noted by those skilled in the art that any aspect disclosed may be performed individually, or that more than two aspects could be combined and performed.

While the disclosure has been described by way of example and in terms of the preferred embodiments, it should be understood that the disclosure is not limited to the disclosed embodiments. On the contrary, it is intended to cover various modifications and similar arrangements. Therefore, the scope of the appended claims should be accorded the broadest interpretation so as to encompass all such modifications and similar arrangements.

What is claimed is:

1. A depth estimation system based on image segmentation, comprising:
a first camera device, configured to capture an observed image;
a second camera device, configured to capture a target image;
a processing unit; and
a storage unit, coupled to the processing unit, storing instructions that, when executed by the processing unit, cause the processing unit to:
generate a first feature map and a second feature map through feature extraction based on the observed image and the target image, respectively;
identify multiple segments in each of the observed image and the target image through an image segmentation process;
for each observed point in the observed image:
compute an epipolar constraint corresponding to the observed point based on extrinsic parameters of the first camera device and the second camera device;
identify, among the multiple segments in the observed image, an observed segment in which the observed point is located;
determine, among the multiple segments in the target image, a target segment matching the observed segment based on the epipolar constraint;
search within the target segment for a target point matching the observed point based on the first feature map, the second feature map, and the epipolar constraint; and
estimate a depth value based on a disparity between the observed point and the target point.

2. The depth estimation system as claimed in claim 1, wherein the processing unit determines the target segment by executing steps comprising:
determining, among the multiple segments in the target image, one or more candidate segments based on the epipolar constraint; and
filtering the candidate segments by selecting only those having a semantic category identical to that of the observed segment.

3. The depth estimation system as claimed in claim 1, wherein the processing unit determines the target segment by executing steps comprising:
determining, among the multiple segments in the target image, one or more candidate segments based on the epipolar constraint; and
filtering the candidate segments by selecting only those having an appearance similarity to the observed segment greater than a similarity threshold.

4. The depth estimation system as claimed in claim 3, wherein the processing unit calculates the appearance similarity between the observed segment and each of the candidate segments based on the first feature map and the second feature map.

5. The depth estimation system as claimed in claim 1, wherein the processing unit determines the target segment by executing steps comprising:
determining, among the multiple segments in the target image, one or more candidate segments based on the epipolar constraint;
calculating an observed distance between the first camera device and a ground point of the observed segment in a bird's-eye view coordinate system;
calculating, for each candidate segment, a candidate distance between the first camera device and the ground point of the candidate segment in the bird's-eye view coordinate system; and
selecting, as the target segment, the candidate segment whose candidate distance has a minimum difference from the observed distance.

6. The depth estimation system as claimed in claim 1, wherein the instructions further cause the processing unit to:
evaluate a distinctiveness score of each of the multiple segments in the observed image and the target image, and assign a texture-less tag to those segments whose distinctiveness score is lower than a distinctiveness threshold;
generate reliable depth information from the depth values estimated for the segments without the texture-less tag, and refine the depth values of the segments having the texture-less tag to obtain refined depth information; and
integrate the reliable depth information and the refined depth information to generate a depth map.

7. The depth estimation system as claimed in claim 6, wherein the processing unit calculates the distinctiveness score of each of the multiple segments based on a variance of feature values within the segment, wherein the variance of the feature values is calculated based on at least one of the first feature map and the second feature map.

8. The depth estimation system as claimed in claim 6, wherein the instructions further cause the processing unit to:
determine, for each of the segments having the texture-less tag, whether the segment has a sufficient number of matching points; and
mark the depth values of those segments having an insufficient number of matching points as invalid in the refined depth information.

9. The depth estimation system as claimed in claim 8, wherein the instructions further cause the processing unit to:
determine, for each of the segments having the texture-less tag with the sufficient number of matching points, whether the depth values of matching points within the segment are continuous; and
mark the depth values of those segments in which the depth values are non-continuous as invalid in the refined depth information.

10. The depth estimation system as claimed in claim 9, wherein the instructions further cause the processing unit to assign interpolated depth values to the segments having the texture-less tag with the sufficient number of matching points and continuous depth values of the matching points, and include the interpolated depth values in the refined depth information.

11. The depth estimation system as claimed in claim 1, wherein the first camera device is a pinhole camera, and the second camera device is a fisheye camera.

12. The depth estimation system as claimed in claim 1, wherein the instructions further cause the processing unit to apply the depth values estimated from the observed points and the target points to perform obstacle detection in at least one of an autonomous navigation system or an advanced driver assistance system.

13. The depth estimation system as claimed in claim 1, wherein the instructions further cause the processing unit to apply the depth values estimated from the observed points and the target points to perform scene reconstruction in an augmented reality or virtual reality system.

14. A depth estimation method based on image segmentation, executed by a processing unit, the method comprising:
generating a first feature map and a second feature map through feature extraction based on an observed image and a target image, respectively, wherein the observed image is captured by a first camera device, and the target image is captured by a second camera device;
identifying multiple segments in each of the observed image and the target image through an image segmentation process;
for each observed point in the observed image:
computing an epipolar constraint corresponding to the observed point based on extrinsic parameters of the first camera device and the second camera device;
identifying, among the multiple segments in the observed image, an observed segment in which the observed point is located;
determining, among the multiple segments in the target image, a target segment matching the observed segment based on the epipolar constraint;
searching within the target segment for a target point matching the observed point based on the first feature map, the second feature map, and the epipolar constraint; and
estimating a depth value based on a disparity between the observed point and the target point.

15. The depth estimation method as claimed in claim 14, wherein determining the target segment comprises:
determining, among the multiple segments in the target image, one or more candidate segments based on the epipolar constraint; and
filtering the candidate segments by selecting only those having a semantic category identical to that of the observed segment.

16. The depth estimation method as claimed in claim 14, wherein determining the target segment comprises:
determining, among the multiple segments in the target image, one or more candidate segments based on the epipolar constraint; and
filtering the candidate segments by selecting only those having an appearance similarity to the observed segment greater than a similarity threshold.

17. The depth estimation method as claimed in claim 16, wherein the appearance similarity between the observed segment and each of the candidate segments is calculated based on the first feature map and the second feature map.

18. The depth estimation method as claimed in claim 14, wherein determining the target segment comprises:
determining, among the multiple segments in the target image, one or more candidate segments based on the epipolar constraint;
calculating an observed distance between the first camera device and a ground point of the observed segment in a bird's-eye view coordinate system;
calculating, for each candidate segment, a candidate distance between the first camera device and the ground point of the candidate segment in the bird's-eye view coordinate system; and
selecting, as the target segment, the candidate segment whose candidate distance has a minimum difference from the observed distance.

19. The depth estimation method as claimed in claim 14, further comprising:
evaluating a distinctiveness score of each of the multiple segments in the observed image and the target image, and assigns a texture-less tag to those segments whose distinctiveness score is lower than a distinctiveness threshold;
generating reliable depth information from the depth values estimated for the segments without the texture-less tag, and refine the depth values of the segments having the texture-less tag to obtain refined depth information; and
integrating the reliable depth information and the refined depth information to generate a depth map.

20. The depth estimation method as claimed in claim 19, wherein the distinctiveness score of each of the multiple segments is calculated based on a variance of feature values within the segment, wherein the variance of the feature values is calculated based on at least one of the first feature map and the second feature map.

21. The depth estimation method as claimed in claim 19, further comprising:
determining, for each of the segments having the texture-less tag, whether the segment has a sufficient number of matching points; and
marking the depth values of those segments having an insufficient number of matching points as invalid in the refined depth information.

22. The depth estimation method as claimed in claim 21, further comprising:
determining, for each of the segments having the texture-less tag with the sufficient number of matching points, whether the depth values of matching points within the segment are continuous; and
marking the depth values of those segments in which the depth values are non-continuous as invalid in the refined depth information.

23. The depth estimation method as claimed in claim 22, further comprising:
assigning interpolated depth values to the segments having the texture-less tag with the sufficient number of matching points and continuous depth values of the matching points, and including the interpolated depth values in the refined depth information.

24. The depth estimation method as claimed in claim 14, wherein the first camera device is a pinhole camera, and the second camera device is a fisheye camera.

25. The depth estimation method as claimed in claim 14, further comprising:
applying the depth values estimated from the observed points and the target points to perform obstacle detection in at least one of an autonomous navigation system or an advanced driver assistance system.

26. The depth estimation method as claimed in claim 14, further comprising:
applying the depth values estimated from the observed points and the target points to perform scene reconstruction in an augmented reality or virtual reality system.
